(19) United States
(12) Patent Application Publication
(10) Pub. No.: US 2010/0072186 A1
(43) Pub. Date: Mar. 25, 2010

(54) ELECTRONIC HEATING MODULE FOR HEATING UP AIR STREAMS, IN PARTICULAR FOR HEATING AND VENTILATING SEATS

(75) Inventor: Ingo Schehr, Jockgrim (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: MICROHELLIX GMBH, Berg (DE)

(21) Appl. No.: 12/525,611

(22) PCT Filed: Jan. 31, 2008
(86) PCT No.: PCT/EP2008/000775

§ 371 Date: Nov. 16, 2009

(30) Foreign Application Priority Data
Feb. 2, 2007 (DE) 102007006058.2

(51) Int. Cl. H05B 1/00; F24H 3/04

(52) U.S. Cl. 219/217; 392/465

(57) ABSTRACT

An electric heating module for heating up air streams, in particular for heating and ventilating seats, which at least one PTC heating element and at least one annular heat dissipation region which is adjacent to said PTC heating element, through which air can flow and which has thermally conductive lamellae which are arranged so as to run in a substantially radial manner and are operatively connected to the PTC heating element and are combined with said PTC heating element to form a module. The lamellae sit, by way of their radially inner portion, in a groove of a thermally conductive retaining ring, which groove is matched to the width of the radially inner portion of the lamellae.

### BACKGROUND

The invention relates to an electric heating module for heating up air streams. This heating module is particularly provided for heating and ventilating seats. It comprises at least one PTC-heating element and at least one annular heat dissipating region, which is adjacent to the PTC heating element, through which air can flow and which has thermally conductive lamellae, which are arranged so as to run in a substantially radial manner and are operatively connected to said PTC heating element and combined therewith to form a module.

PTC-elements are semiconductor resistors made from ceramics, with their ohmic resistance depending on temperature. The resistance-temperature characteristic is not a linear one: the resistance of a PTC-heating element first drops slightly when the temperature of the part increases, in order to then rise sharply at a characteristic temperature (reference temperature). This overall positive progression of the resistance-temperature characteristic (PTC=Positive Temperature Coefficient) leads to such a PTC-heating element showing self-regulating features. At a parts temperature which is considerably lower than the reference temperature the PTC-heating element shows low resistance so that appropriately high currents can be conducted. When good heat dissipation is ensured at the surface of the PTC-heating element respectively high power input occurs and is dissipated in the form of heat. However, when the temperature of the PTC-heating element rises above the reference temperature the PTC-resistance increases rapidly so that the power input is limited to a very low value. The part's temperature then approaches an upper limit, which is dependent on the heat absorption of the environment of the PTC-heating element. Thus, under standard environmental conditions the parts temperature of the PTC-heating element cannot rise above a characteristic maximum temperature even if the intended heat dissipation is entirely interrupted by malfunction. This fact and the self-controlling features of a PTC-heating element, due to which the power input is precisely equivalent to the thermal power released, recommends PTC-heating elements for the use in heating and/or air-conditioning systems of vehicles or in other applications of heating airflows in vehicles. In this field of application no fire-hazardous temperatures may develop in the heating element for safety reasons, even in case of malfunction, yet high thermal output is required in normal operation.

In order to heat the passenger cabin of motor vehicles it has been known to use electric heating modules with a frame, combining a multitude of PTC-heating element and adjacent heat dissipating regions, through which air can flow, with heat-conducting lamellae to form a module. An example for such known electric heating modules is found in EP 0 350 528 A1.

EP 1 479 918 A1 discloses a complete ventilation module comprising a radial ventilator integrated in a housing and a heating module of the type mentioned at the outset, which is to serve for heating the seat in a ventilated motor vehicle seat. Due to the fact that for safety reasons, even when the ventilator malfunctions, a motor vehicle seat must not exceed a maximum temperature tolerated by humans at its surface, heating modules with PTC-heating elements are excellently suited, particularly since showing the same level of safety, they can emit a considerably higher heating power than conventionally used mats with electric resistance wires with their power input requiring tight limits for safety reasons.

The previously known electric heating modules of the type mentioned at the outset generally comprise several layers of planar PTC-heating elements, arranged side-by-side and facing the airflow at their narrow side, each of which electrically contacting contact sheets with their flat upper sides and their lower sides. The adjacent heat dissipation regions comprise metal lamellae, arranged in a meandering fashion, which also face the airflow with their narrow side and, placed thereupon, thermally contact the contacting sheets of the PTC-heating elements at their broadside in regular intervals for the heat transfer. In order to allow good heat dissipation from the PTC-heating elements to the heat-conducting lamellae, heat conducting adhesives or other connection techniques can be used; however, it has proven most efficient to place the PTC-heating elements and the heat-conducting lamellae into a frame combining them to a module and to provide at least one spring element inside said frame, which compresses the alternating arranged heat dissipating regions with heat-conducting lamellae and the bars with the PTC-heating elements.

However, this requires a rectangular shape of the electric heating module having a linear structuring of its components, which is particularly not fluidically optimal for heating airflow when the space for the respective air conducting channels, like in a motor vehicle, is rather limited. Consequently, according to EP 1 479 918 A1 the ventilation module for motor vehicle seats was provided with a radial ventilator. Radial ventilators are rather poorly suited for this purpose, though, because they create high pressure with correspondingly high outflow speeds.

Furthermore, the production of the known electric heating modules is hardly possible in an automated fashion due to the multi-layered, spring-loaded design inside the frame. Here, rather relatively large portions of manual labor are necessary.

Therefore, DE 20 2005 012 394 U1 suggests an electric heating module of the type mentioned at the outset, comprising an annular, particularly circularly embodied heat dissipation region, in which the heat conducting lamellae are arranged extending essentially radially. This facilitates the assembly, particularly when it shall occur in an automated fashion, and increases the efficiency of the heat transfer to the airflow guided through the lamellae and/or the heat dissipation region.

Another example for a ventilation module for motor vehicle seats is found in EP 1 464 533 A1. An example for heating modules integrated in a motor vehicle seat and comprising a fan and resistance-heating wires in the airflow like a hair dryer, is described in U.S. Pat. No. 6,541,737 B1.

### SUMMARY

Based on this prior art, the object of the present invention is to improve an electric heating module of the type mentioned at the outset with regard to the ease of its assembly as well as concerning the installation space required in a seat.

This object is attained in an electric heating module having the features of the invention. Preferred embodiments and further developments of the invention are disclosed below, along with a preferred application of the heating module according to the invention.

The present invention improves the previously known design of an electric heating module of the type mentioned at the outset such that a heat-conducting retainer ring is provided with a groove, essentially encircling the perimeter, in which the lamellae are seated with their respective radially inner section and/or end. The groove of the retainer ring is adjusted to the width of the radially inner section of the lamellae such that they can also be inserted into said groove. Although it is preferred to produce the retainer ring in a cylindrical form, within the scope of the invention a flat, elliptical or sectionally straight annular form and a polygonal shape is also possible, though, as is the case for the heat dissipating region with the heat conducting lamellae. Further, the term “ring” relates essentially to the ring-shaped groove in the retainer ring, while the fastener itself may also represent a massive disk or a hollow disk, or perhaps may even comprise several parts and/or sections. It is only important that the lamellae are placed in an essentially circumferential groove of the heat conducting retainer ring, are held there, and dissipate heat therefrom.

The groove of the retainer ring according to the invention, in which the lamellae are located, can be formed by two circumferential bars, with the retainer ring preferably showing the shape of an I-beam in its side view. As already mentioned, the retainer ring is preferably shaped cylindrically, particularly at least in the area of the groove. This way, a circular heat dissipation region develops with lamellae of a constant radial extension, which is aerodynamic and therefore preferred.

It is not necessary for the groove of the retainer ring to be formed completely circumferential, rather it may comprise a gap, for example, through which an electric contact can be guided.

Particular advantages develop when the fastener according to the invention is produced as an extruded aluminum part. Extruded aluminum parts show particularly good thermal conductivity so that the heat flow from the PTC-heating element to the heat dissipating lamellae is also particularly high, typical for the operation of the electric heating module according to the invention.

A particularly efficient and advantageous production of the electric heating module according to the invention is possible in that the lamellae are held clamped between the lateral walls of the groove; when the groove is formed by two circumferential bars this may be achieved such that the bars are swaged (caulked) or compressed with the lamellae. In addition to high stability of this connection, very good heat transfer develops from the retainer ring into the lamellae, and said connection can be produced automatically in a fast and efficient manner.

Particularly in this context it is advantageous for the lamellae to be made from at least one meandering bent and/or folded metal strip. In this case the radially inner ends of the lamellae and/or the radially inner sections of the lamellae are bent in the form of an outer bead so that here particularly high stability develops in the lateral direction, thus from one narrow side to other narrow side of the lamellae. The clamping or swaging of the lamellae in the groove of the retainer ring can then occur with strong forces, further improving the above-mentioned high stability and high heat conductivity of the connection by the lamellae forcefully inserting the lateral walls of the groove.

In order to optimize the guidance of the airflow through the heat dissipating region with regard to an optimum heat transfer from the lamellae to the air said lamellae may be embodied such that their narrow sides extend essentially bent in a sickle-shaped manner. Alternatively or additionally the lamellae may be distorted in their radial progression such that their broadsides are tilted, at least partially, in reference to the axial direction and thus against the direct direction of the airflow. These shapes result in deflections and eddies in the airflow, which allow perhaps to increase the convective heat dissipation in the air and thus to add to the heat dissipation via the lamellae. Then, the power output of the PTC-heating elements increases accordingly and consequently also the one of the entire electric heating module.

A preferred, fundamental way to arrange the PTC-heating element at the retainer ring according to the invention states that the retainer ring comprises an essentially radially extending contact surface for a direct or indirect heat contact to the PTC-heating element, so that the PTC-heating element sits with its broadside on the retainer ring perpendicularly in reference to the direction of the airflow.

A particularly compact and advantageously produced further development of this principle comprises two retainer rings, arranged behind each other, having inserted lamellae in the axial direction, while the PTC-heating element is arranged between the retainer rings and is in a heat-conducting contact with both retainer rings, particularly placed directly between the two contact surfaces of the two retainer rings and thus it is not only in a heat-conductive contact with the retainer rings but also abutting them in an electrically contacting fashion. Accordingly it is beneficial for the retainer rings to be provided with connector elements for electrical contact, rendering a separate contact to the PTC-heating element unnecessary.

Here, it is also beneficial when a soft-elastic gasket is inserted between the two contact surfaces of the two retainer rings and circumferentially surrounding the PTC-heating element. This results in it being encapsulated moisture-tight between the retainer rings and the risk for the two retainer rings to come into an electric contact with each other is eliminated, for example by contaminants entering through the gap and developing short circuitry. Beneficially, the soft-elastic gasket has a cross-section which is radially enlarged towards the outside. Because radially inwardly it must allow for the PTC-heating element to be contacting the contact surfaces of the two retainer rings as tight as possible and with a certain compressive force, while towards the outside the sealing effect of the soft-elastic gasket is of primary importance.

In order to further improve the electric heating module according to this first alternative embodiment, three or more retainer rings may also be arranged instead of two retainer rings, with the respective lamellae each arranged axially behind each other, while at least one PTC-heating element is located between two neighboring retainer rings each, being in a heat-conductive contact to both adjacent retainer rings. Here, two PTC-heating elements require three retainer rings, three PTC-heating elements four retainer rings, etc. When the PTC-heating elements can be connected separately to electric power a selective operation for the heating power of the overall module develops. For this purpose, different PTC-heating elements may also be used so that the individually selected steps of the overall module show different power levels.

In order to achieve high strength of the electric heating module according to the invention and to exclude any risk for short circuiting by incoming moisture, contaminations, or electrically conductive foreign objects, the PTC-heating elements can also be contacted such that the lamellae packages are not electrically conducting. Here, the electric connector elements are each arranged between the PTC-heating element and the two contact surfaces of the two retainer rings, with an electrically insulating but heat conductive film being placed between each electric connector element and the contact surface of the allocated retainer ring. The retainer rings are therefore electrically insulated from the PTC-heating element.

In this case the above-mentioned soft-elastic gasket between the two contact surfaces of the two retainer rings has been replaced, preferably by a positioning ring. Said ring circumferentially surrounds not only the PTC-heating element but also the electric connecting elements, with recesses may be provided in the positioning ring in order to guide the electric connector elements to the outside. A package comprising a PTC-heating element, two electric connector elements, a positioning ring surrounding them, and one insulating film applied each at the top and at the bottom therefore offers the maximum protection possible against incoming moisture or contamination of the electrically conducting parts of the electric heating module. When the positioning ring is provided with insulating bars for the electric connector elements it additionally ensures that the parts of the connecting elements leading out of the positioning ring cannot accidentally be pressed against the respectively other contact surface of the retainer rings, which could potentially result in a short circuit.

A second general alternative to further develop the present invention comprises that the annular fastening is divided along an axially extending separating plane, with the PTC-heating element being located in the separating plane between the two parts of the retainer ring. Here, the PTC-heating element is arranged with its broadsides aligned longitudinally in reference to the airflow; if it were placed in the airflow, the airflow would therefore impinge a narrow side of the PTC-heating element. Based on this second alternative it is clearly shown once more that the retainer ring in the sense of the present invention is not necessarily a ring in the conventional sense of the word, but may also comprise two or more individual parts or show different shapes.

Each half of the retainer ring of this second fundamental alternative may comprise a contact surface adjacent to the separating plane, which the PTC-heating element contacts in an electrically and heat-conductive manner. The PTC-heating element is therefore inserted between the two halves of the retainer ring, with preferably a gasket or a frame being provided to accept the PTC-heating element. This frame prevents that excessive forces act upon the PTC-heating element and also seals it from the outside.

It is particularly advantageous for manufacturing when the two halves of the retainer ring are combined by clips, particularly spring clips. This results in a compression between the halves of the retainer ring and the PTC-heating element, which improves the electric contacting and particularly the heat transfer.

The two above-described preferred fundamental alternatives further developing the invention may be provided with two (or more) radial gaps between the lamellae in the heat dissipation region, in order for each of them to accept a fastening bar and perhaps guide an electric conductor. This allows a particularly simple and automated assembly of the electric heating module. Because then the retainer rings with the lamellae mounted thereto only have to be placed upon the fastening bars, by which they automatically are aligned axially in reference to each other. Then the fastening bars only need to be closed at the top and bottom, with a spring element ensuring pre-stressing the retainer rings against the PTC-heating elements.

This may be embodied such that an essentially U-shaped fastener is provided with at least two fastening bars serving as U-legs, with a spring element being mounted to the U-back of the fastener such that the retainer rings with the lamellae are inserted into the U-shaped fastener and that a clip is placed upon the ends of the fastening bars fixing the retainer rings and pre-stressing them against the spring element. Alternatively the spring element at the U-back of the fastener can be omitted, with the clip being replaced by a spring clip or a spring bar.

In another embodiment the fastening bars can be connected to each other via snaps, resulting not only in a U-shaped fastener but ultimately in an annular shaped fastener. The snap closure preferably occurs via at least one centering element to accept a spring element so that ultimately again a U-shaped fastener develops. When two centering elements are used, a retainer ring results which can be installed in an interlocking manner.

In all above-mentioned alternatives it is advantageous when at least one fastening bar shows penetrations for the electric connector elements, so that they can be guided from the retainer rings through the fastening bar towards the outside without contacting the lamellae packages and there be connected via cables, plugs, or the like from the outside. This is particularly important for the application of heating modules according to the invention in motor vehicles, because here the voltage is limited and accordingly high current and thus accordingly large wire cross-sections of the electric connector elements are necessary in order to ensure the desired heating power of the heating module.

Preferably the fastening bars are mounted to a housing allowing airflow or integrated therein, while a ventilator is mounted to the housing or inserted therein. The housing may particularly be designed for installation in a seat.

Particular advantages result from the electric heating module according to the present invention when it is used as the ventilator in a ventilated seat, particularly in a ventilated vehicle seat, with optionally heated airflow, allowed by the PTC-heating element and the heat conducting lamellae, which can be gradually added as heating for the seat, perhaps.

### BRIEF DESCRIPTION OF THE DRAWINGS

Using the attached drawings, several exemplary embodiments of the present invention are described in greater detail and explained in the following. It shows:

FIG. 1 a perspective exploded view of a first exemplary embodiment of the heating module according to the invention;

FIG. 2 the heating module of FIG. 1 in the pre-assembled state;

FIG. 3 the heating module of FIG. 1 in the assembled finished state;

FIG. 4 another perspective view of the heating module of FIG. 3;

FIG. 5 a perspective exploded view of a second exemplary embodiment of the electric heating module according to the invention;

FIG. 6 a perspective exploded view of a third exemplary embodiment of the electric heating module according to the invention;

FIG. 7 a perspective exploded view of a fourth exemplary embodiment of the electric heating module according to the invention;

FIG. 8 a perspective exploded view of a fifth exemplary embodiment of the electric heating module according to the invention;

FIG. 9 the heating module of FIG. 8 in the assembled state;

FIG. 10 a perspective exploded view of a section of the heating module of FIG. 1;

FIG. 11 a perspective exploded view according to FIG. 1, however showing another exemplary embodiment;

FIG. 11a a perspective drawing of a section of FIG. 11 in the assembled state;

FIG. 12 a perspective exploded view of another exemplary embodiment of the heating module according to the invention without its housing;

FIG. 13 a perspective view of the electric heating module of FIG. 12, from the top, in the assembled state;

FIG. 14 a perspective view of the electric heating module of FIG. 12, from the bottom, in the assembled state.

### DETAILED DESCRIPTION OF THE PREFERRED EMBODIMENTS

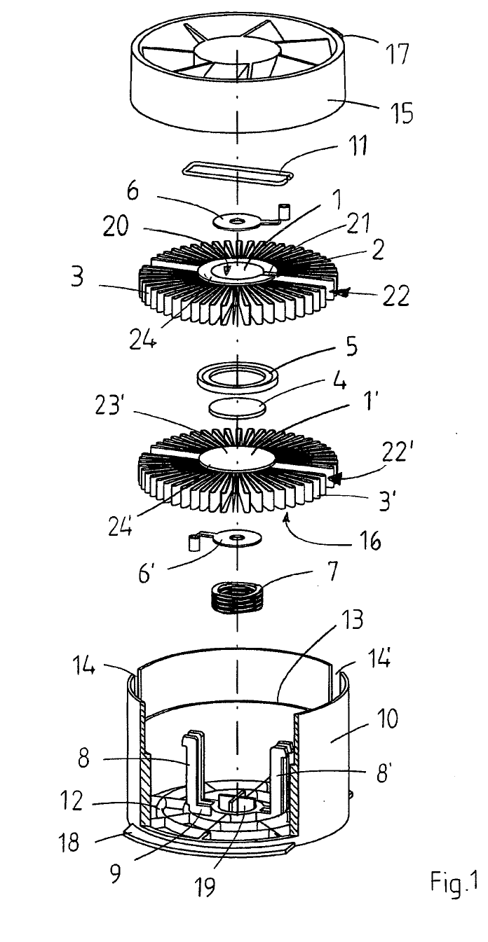

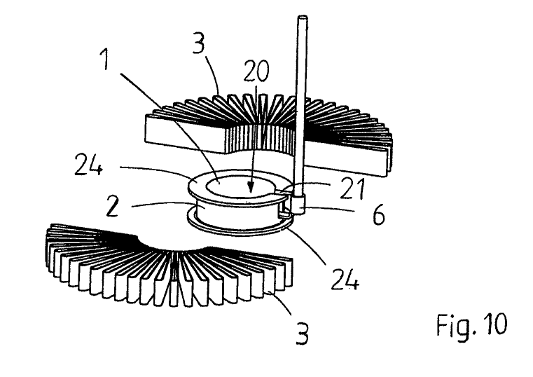

The electric heating module according to a first exemplary embodiment of the present invention shown in FIG. 1 in a perspective exploded view essentially comprises in its core two retainer rings 1, 1′ with a circumferential cylindrical groove 2 (see FIG. 10), in which the radially arranged, heat conducting lamellae 3, 3′ are located, a PTC-heating element 4 in the form of a round disk arranged between the two retainer rings 1, 1′, a soft-elastic gasket 5 surrounding the PTC-heating element 4, two electric connector elements 6, 6′ formed with eyelets, a spring element 7 embodied as a corrugated pressure spring, and two fastening bars 8, 8′ each embodied in two parts, which form the U-legs of a U-shaped fastener 9 integrated in a housing 10 and complemented with a clip 11. The housing 10 is opened in the present illustration in order to render the interior parts visible, particularly the U-shaped fastener 9. It is essentially of a cylindrical shape in order to form a duct for laminar airflow, if possible, which is supported by the air guidance bars 12 at the inlet. At the outlet of the housing 10 an receptacle for plugging in a ventilator 15 is formed by a protrusion 13 and plug-in grooves 14, 14′, said ventilator draws the airflow through the heat dissipation regions 16 formed by the rings of lamellae 3, 3′. The ventilator is plugged into the plug-in groove 14 in the housing 10 via a catch 17. The housing 10 is additionally provided with assembly bars 18 for installation in a vehicle seat.

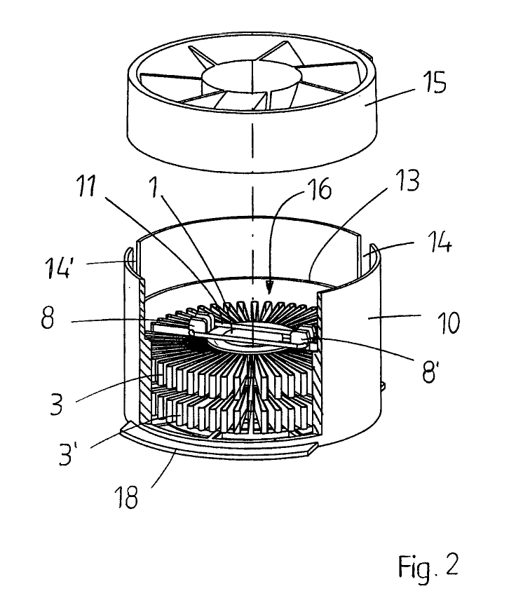

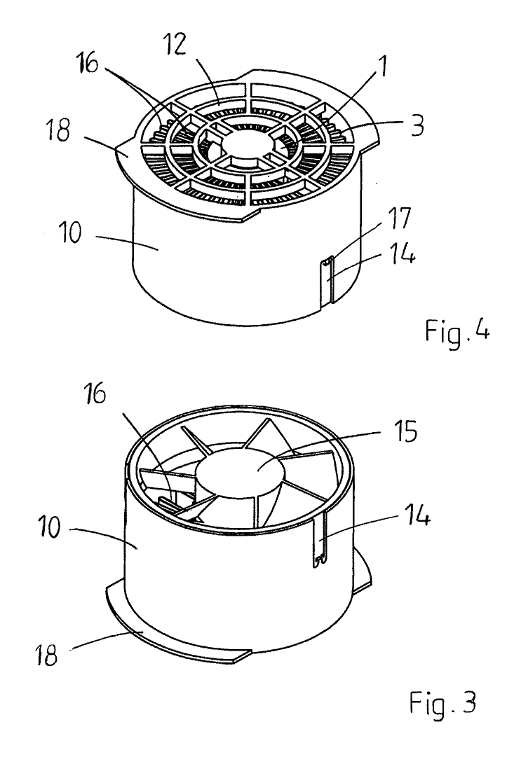

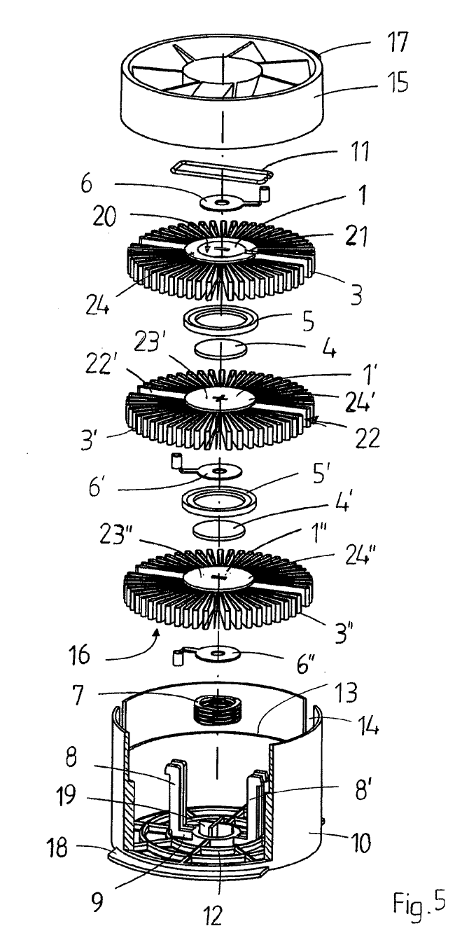

When analyzing FIGS. 1 and 2 together the potential automated assembly of the present exemplary embodiment of an electric heating module according to the invention is discernible. The spring element 7 is placed upon the elastic seat 19 forming a portion of the U-shaped back of the fastener 9 integrated in the housing 10. The connector elements 6, and 6′ are each inserted into an open interior space 20 of the retainer rings 1, 1′, and the eyelet is guided through an opening 21 in the retainer rings 1, 1′, with then the lower retainer ring 1′ with its lamellae 3′ and the inserted electric connector element 6′ being placed upon the spring element 7, with the fastening bars 8 reaching through two opposite gaps 22′ in the heat dissipation region 16 and/or in the lamellae 3′ and aligning the retainer ring 1′ in its radial position. Subsequently the soft-elastic gasket 5, embedded in the PTC-heating element 4, is placed upon a radially extending contact surface 23′arranged at the retainer ring 1′. Then the upper retainer ring 1 is placed, aligned opposite, onto the PTC-heating element 4 embedded in the gasket 5, with the retainer ring 1 also comprising a contact surface 23 contacting the PTC-heating element 4 in an electrically and heat-conductive manner. The fastening bars 8, 8′ of the fastener 9 pass through gaps 22 in the lamellae 3 of the upper retainer ring 1 such that the upper retainer ring 1 with the inserted electric connector element 6 is also radially aligned. The division of the two fastening bars 8, 8′ allows here that the eyelet of the electric connector element 6 can be guided to the outside through the U-legs of the fastener 9. In order to finally allow the clip 11 to be mounted to the fastener 9 and/or the fastening bars 8, 8′ such that it snaps underneath the beads there, so that the retainer rings 1 are pre-stressed against the spring element 7. The clip 11 maintains said pre-stressing and thus ensures an excellent heat transfer as well as low electric resistance between the PTC-heating element 4 and the two contact surfaces 23, 23′ of the retainer rings 1, 1′. The soft-elastic gasket 5 has a cross-section radially enlarged towards the outside, so that any jamming of the retainer rings 1, 1′ with each other is excluded, which could cause short-circuitry. Simultaneously the gasket 5 ensures that the PTC-heating element 4 and the contact surfaces 23, 23′ are protected from moisture and contamination. Here it should be mentioned that the clip 11 can also be exchanged for a spring clip or a spring bar, eliminating the spring element 7 and saving height. Alternatively, the spring element 7, particularly embodied as a corrugated tension spring, can also be arranged at the top, underneath the clip 11, perhaps with an intermediate pressure distributing cap in order to achieve higher stability of the structure during the assembly. After the ventilator 15 has been finally inserted into the housing 10, the finished part develops for heating and ventilating seats, shown in FIGS. 3 and 4. The assembly bars 18 or assembly flanges allow a low-maintenance installation in motor vehicle seats. The insertion grooves 14 in the housing 10 serve, on the one hand, to guide and prevent rotation of the ventilator 15 in the housing 10 via its catch 17; at the opposite side the insertion groove 14′ serves to guide the electric connector cable necessary for the ventilator 15 and the PTC-heating element 4.

As illustrated in detail in FIG. 10, the extruded aluminum part used in the exemplary embodiment according to FIGS. 1 through 4 as the retainer ring 1, 1′ shows in its side view the shape of an I-beam, with only one of the two I-beam surfaces being embodied as a disk, namely as the contact surface 23, while the opposite side of the retainer ring 1 being open in order to allow accepting the connector element 6. The groove 2 is formed by two edge bars 24, with one edge bar 24′ representing the outer perimeter of the contact surface 23′. The heat conducting lamellae 3, 3′ are each formed by two aluminum strips, which combined meandering form the annular surface of bent and folded annular lamellae parts, each overlapping by half, so that the gaps 22, 22′ remain open therebetween. If applicable, the heat dissipation region 16 may also be comprised from several individual annular lamellae parts.

The lamellae 3 are positioned in their radially inner section in the groove 2 of the retainer ring 1, with the width of groove 2 being precisely equivalent to the width of the metal strips so that it can be inserted into the groove 2 in an axially and radially aligned manner. Any compression and/or swaging of the edge bars 24 of the retainer rings 1 inwardly against the lamellae 3 causes a deformation of the lateral walls of the groove so that the narrow sides of the lamellae, due to the increased stability of the lamellae in the axial direction by the radially inner folds, impress the lateral walls of the groove and form a close, heat-conducting connection to the retainer ring 1. Therefore, excellent heat conductivity from the PTC-heating element 4 to the retainer ring 1 is ensured, due to the given pre-stressing in the assembled state and the excellent heat conductivity from the retainer ring 1 to the heat-conductive lamellae 3.

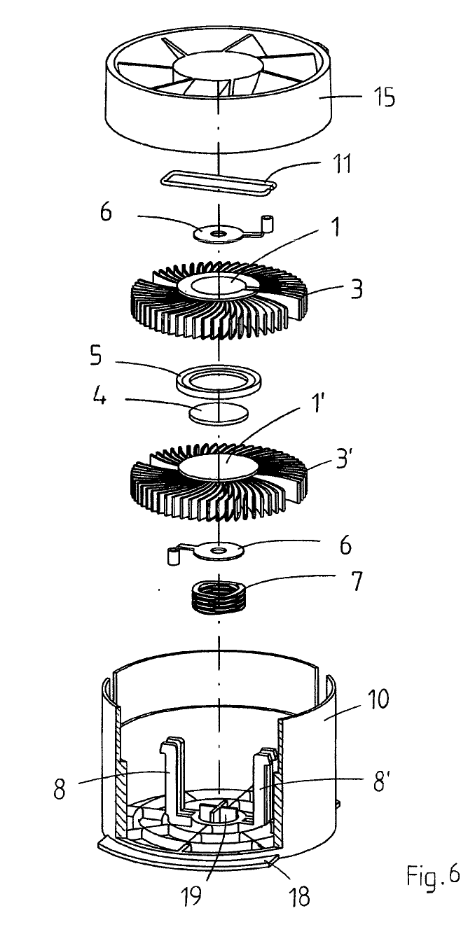

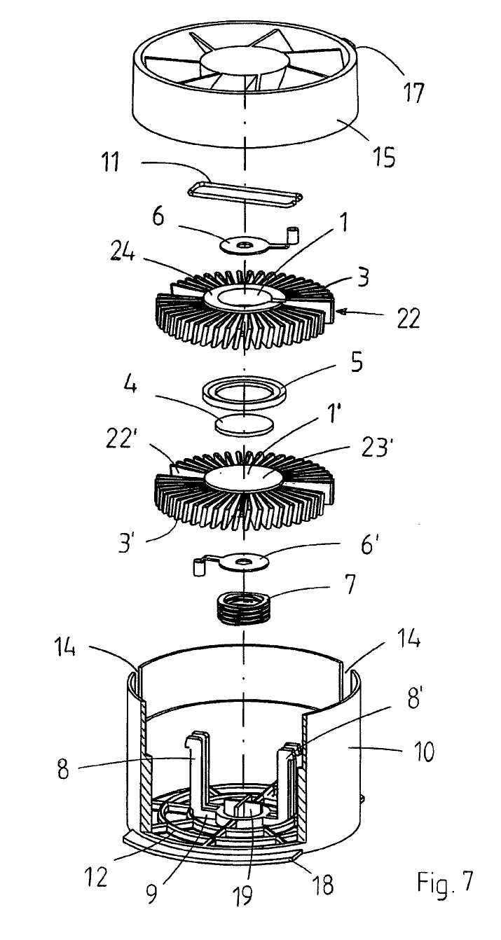

The heat transfer from the heat conductive lamellae 3, 3′ into the airflow, drawn by the ventilator 15 through the housing 10 and the heat dissipation region 16, can be optimized by varying the shape of the lamellae 3, 3′. Here, examples can be found in the exemplary embodiments according to FIGS. 6 and 7, which differ only in the shapes of the lamellae 3, 3′ deviating from the exemplary embodiment according to FIGS. 1 through 4.

In the exemplary embodiment shown in FIG. 6 the lamellae 3 are bent sickle-shaped in their radial progression, which considers that the ventilator 15 creates an almost eddy-free airflow in its intake area, however shows no precisely axially progressing flow vectors. Here, the lamellae 3, 3′ may again be bent or folded in a meandering fashion; however they may also be made from individual metal strips.

The exemplary embodiment shown in FIG. 7 also has lamellae 3, 3′ folded in a meandering fashion, however, they are not axially aligned such that their broadsides extend precisely in the axial direction, rather they are slightly tilted in reference to said axial direction so that the axial airflow also impinges a projection of the broadsides. Accordingly the lamellae 3, 3′ are swaged in the groove 2 of the retainer ring 1 in the tilted state. Due to the fact that this is not easily accomplished in manufacturing, the lamellae 3 may also be positioned perpendicularly in the groove 2, as it is the case in the two previous exemplary embodiments, and the lamellae 3 are subsequently distorted, by being twisted around a radial axis, in order to create the tilting of the lamellae 3 in the heat dissipation region 16 shown in FIG. 7.

FIG. 5 shows an exemplary embodiment for an electric heating module according to the invention, which is essentially equivalent to the exemplary embodiment shown in FIGS. 1 through 4. However, here three retainer rings 1, 1′, 1″ with the respective lamellae 3, 3′, 3″ are arranged over top of each other, and one PTC-heating element 4, 4′ is arranged between each pair of retainer rings 1, 1′, 1″ each in the manner described in FIG. 1, and embedded in a gasket 5, 5′. Thus the two PTC-heating elements 4, 4′ act upon a common lamellae package 3′ and additionally each upon their own lamellae package 3 and/or 3″. They may be provided with different power intakes and the lamellae packages 3, 3′, 3″ may also be embodied differently, particularly with regard to the height of the lamellae. The electric contacts can here be limited to three connector elements 6, 6′, 6″, because two PTC-heating elements 4, 4′ share a common electric connector 6′.

The arrangement shown in FIG. 5 allows a gradual switching of electric heating energy into the airflow created by the ventilator 15, where presently two settings can be switched. If an appropriately higher number of retainer rings 1 with lamellae packages 3 is stacked over top of each other more settings of heating power can be realized that can be switched. If no PTC-heating element 4, 4′ is connected to electric power the electric heating module according to the invention operates as ventilation for a motor vehicle seat. An initial, appropriately low heat setting would allow a temperature-controlled ventilation of the motor vehicle seat, for example, without creating the subjective sensation of heating in the person sitting thereon.

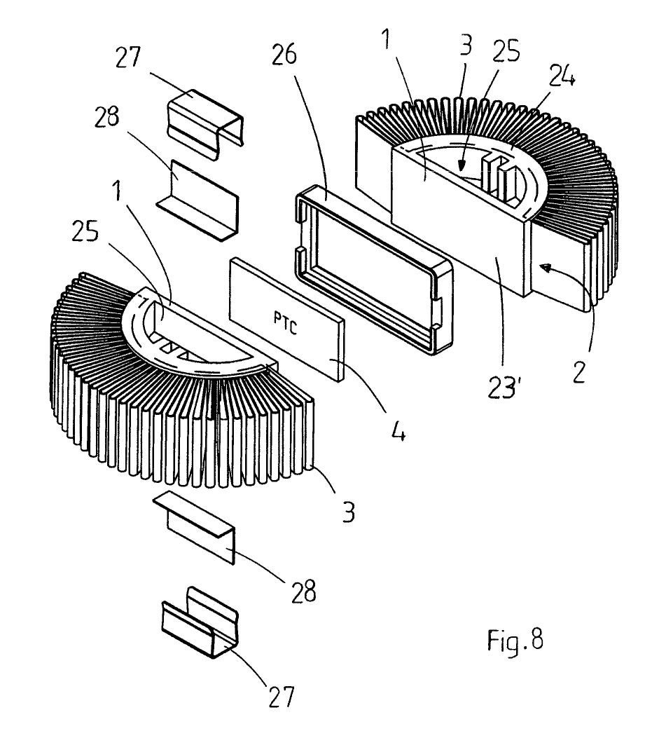

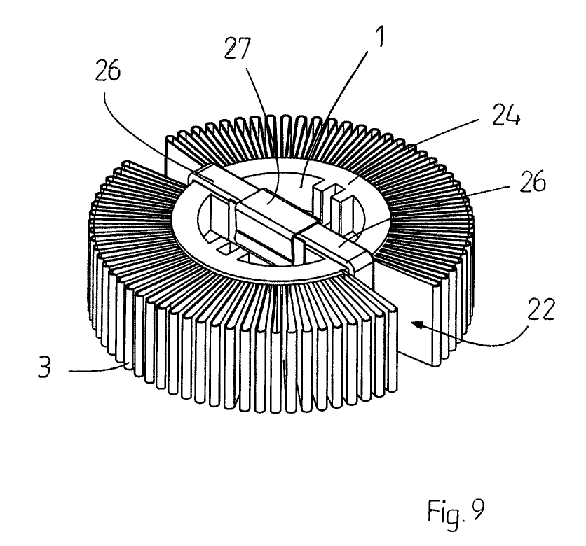

Finally, FIGS. 8 and 9 show another exemplary embodiment of an electric heating module according to the invention, which again can be inserted in a housing having a ventilator, which is not shown, here. This other exemplary embodiment realizes an alternative exemplary embodiment of a retainer ring 1 according to the invention, because it is here divided into two halves 25, 25′, which are separated from each other. Each half of the retainer ring 1 comprises an axially extending contact surface 23, 23′ in the separation plane between the two halves 25, 25′ such that the PTC-heating element 4 is positioned axially rather than radially aligned between the contact surfaces 23, 23′ and is contacted thereby in an electrically and heat conducting fashion. A mounting frame 26 made from plastic ensures precise alignment of the PTC-heating element 4 as well as the two halves 25, 25′ of the retainer ring 1 in reference to each other, while two spring clips 27 fix the two halves 25, 25′ of the retainer ring 1 to each other. The fastening clips 27 are each coated with an insulation 28 at one side, so that each spring clip 27 electrically contacts only one half 25, 25′ of the retainer ring 1.

As clearly discernible from FIG. 9, again at both sides, a gap 22 remains between the respective lamellae packages 3 of the two halves 25, 25′ of the retainer ring 1, into which a fastener 9 (comprising an insulating material) can be inserted, for example the fastening bars 8 of FIGS. 1 through 7 made from plastic, in order to install the electric heating module in a ventilator housing.

In spite of the ability of division via axially extending separation planes the retainer ring 1 the exemplary embodiment shown in FIGS. 8 and 9 is principally designed as the exemplary embodiments shown in FIGS. 1 through 7. Because it comprises an aluminum part produced as an extruded component with circumferential upper and lower edge bars 24, to form a cylindrical groove 2 circumferential at the outside. The lamellae 3, made from aluminum sheets bent in a meandering fashion, are positioned in said groove 2 and here compressed by the edge bars 24 being swaged.

The exemplary embodiment of the electric heating module according to the invention shown in FIGS. 8 and 9 allows a lower construction height and may therefore be advantageous. However, generally the emitted heating power will probably be lower than in the other embodiments described. All embodiments have in common the highly efficient heat transfer from the PTC-heating elements to the heat conducting lamellae without the need to adhere or solder the lamellae.

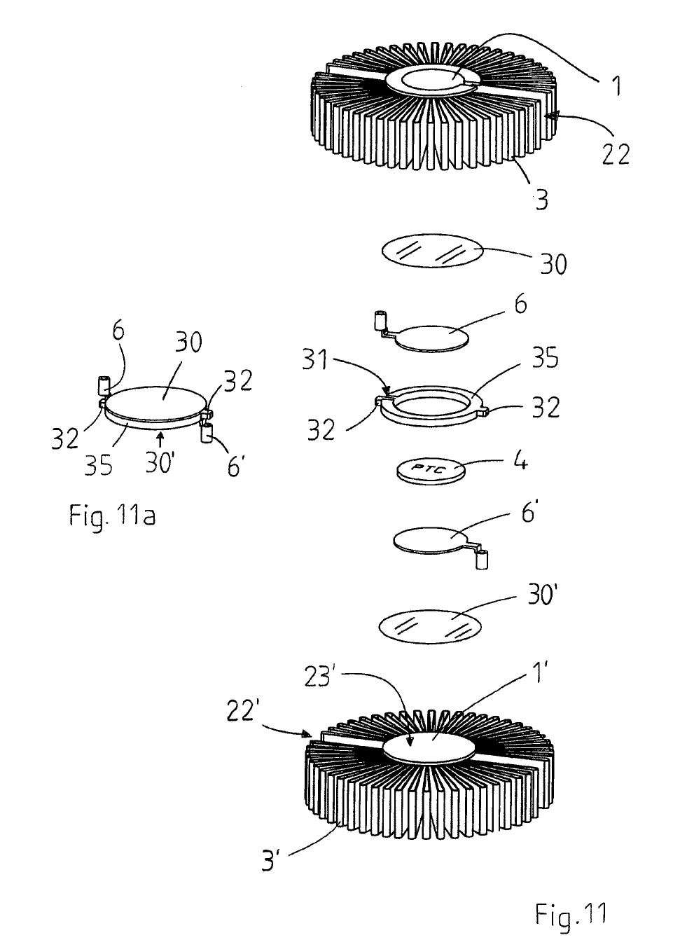

FIG. 11 also shows, similar to FIG. 1, an electric heating module in a perspective exploded view. It represents another exemplary embodiment of the present invention, with the modification in reference to the module shown in FIG. 1 essentially relating to the electric contacts; because the electric connector elements 6, 6′ are here each arranged between the PTC-heating element 4 and the contact surfaces 23, 23′ of the retainer rings 1, 1′. The heating module shown in FIG. 11 comprises two retainer rings 1, 1′ with a circumferential cylindrical groove, with radially inserted heat conducting lamellae 3, 3′, a PTC-heating element 4 in the form of a round disc arranged between the two retainer rings 1, 1, a positioning ring 35 made from plastic surrounding the PTC-heating element 4, as well as two electric connector elements 6, 6′ having eyelets. Two opposite gaps 22, 22′ are each arranged in the circularly arranged lamellae 3, 3′, through which the fastening bars (not shown here) can pass.

The arrangement of the electric connector elements 6, 6′ in the heating module shown in FIG. 11 differs from the heating modules shown in the previously figures, as already mentioned, in each electric connector elements 6, 6′ sitting directly on the PTC-heating element 4 as well as by the positioning ring 35. The latter is embodied relatively large in order to allow accepting the package as a whole, formed by the two electric connector elements 6, 6′ and the PTC-heating element 4, with it showing a slightly lower height than said package though, in order to prevent interfering with the strong compression and thus the good heat transfer between the PTC-heating element 4 and the two retainer rings 1, 1′. The electric connector elements 6, 6′ are each separated from the contact surfaces 23, 23′ of the retainer rings 1, 1′ via a heat-conducting but electrically insulating film 30, 30′. This insulating film 30, 30′ preferably represents a thermally stable polyamide film and is embodied adhesive on one side for a particularly easy assembly. Therefore an electric connector element 6 and an insulating film 30 are positioned between each of the surfaces of the PTC-heating element 4 and the retainer rings 1, 1. The advantage resulting here comprises that neither the retainer rings 1, 1′ nor the heat-conducting lamellae 3, 3′ are electrified; due to the fact that they are connected to the same electric potential any short circuitry between the lamellae 3 of the first retainer ring 1 and the lamellae 3′ of the second retainer ring 1′ is even excluded when moisture or contaminants enter the electric heating module or accidentally an electrically conductive part, such as a nail, enters the airflow.

As discernible from FIG. 11a, the combination of the PTC-heating element 4 and the two electric connector elements 6, 6′, the positioning ring 35, and the insulating film 30, 30′ result in a package preventing the advancement of moisture to the PTC-heating element 4. This is enhanced in that the positioning ring 35 comprises two recesses 31 for the guidance of the electric connector elements 6, 6′. Except for the recesses 31 for the guidance of the electric connector elements 6, 6′ the positioning ring 35 also comprises insulating bars 32. These insulating bars 32 ensure that even when a power cable (not shown) is inserted with excessive force into the electric connector elements 6, 6′, no accidental contact can develop between the electric connector element 6 and the contact surface 23′ of the retainer ring 1′ or inversely a contact of the electric connector element 6′ with the contact surface 23 of the retainer ring 1 and thus cause a short circuit.

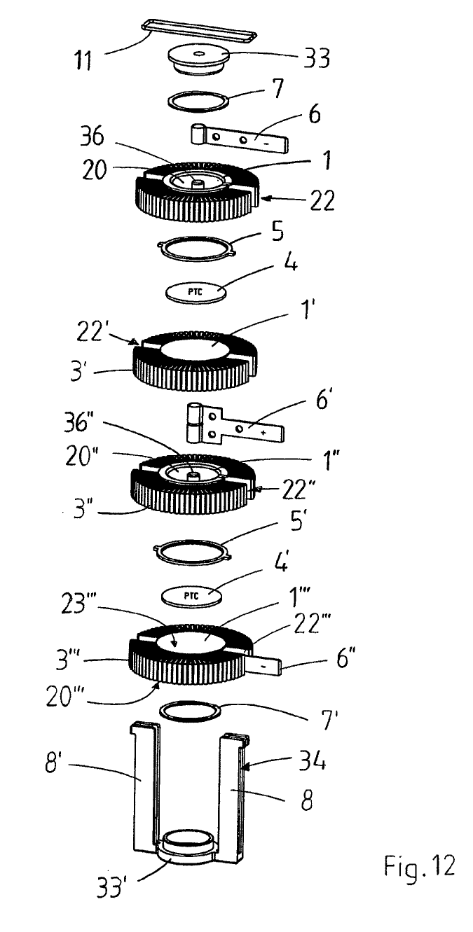

FIGS. 12 through 14 show an exemplary embodiment for an electric heating module according to the present invention, which is produced without any housing and if necessary can be used in a ventilation shaft, for example. It comprises four retainer rings 1, 1′, 1″ 1″′ with heat conducting lamellae 3, 3′, 3″, 3″′, which only accept two PTC-heating elements 4, 4′ between each other, though. Each of the two PTC-heating elements 4, 4′ acts upon two lamellae packages 3, 3′ and/or 3″, 3″′. They can be embodied identical or have different power input levels.

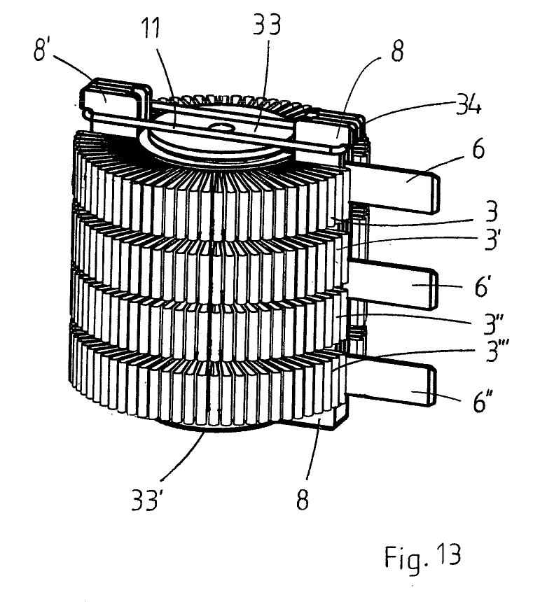

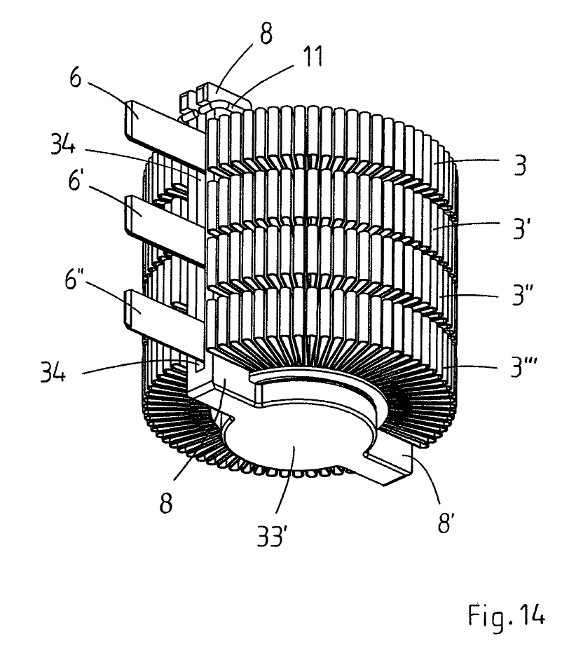

FIG. 12 shows the design of this exemplary embodiment of an electric heating modules in detail, while FIGS. 13 and 14 illustrate the heating module in the assembled state, from a perspective from the top (FIG. 13) and a perspective from the bottom (FIG. 14.). A bottom centering element 33′, snapped to a right 8 and a left fastening bar 8′, carries a spring element 7 and accepts the open interior space 20″′ of the lowermost retainer ring 1″′ in a centering manner. At the rear of the lowermost retainer ring 1″′, thus on its contact surface 23″′, the first PCT-heating element 4′ is positioned, which is embedded in a first soft-elastic gasket 5′. The contact surface 23″ of the second-to-bottom retainer ring 1″ then sits on the bottom of the PTC-heating element 4′ in order to complete the lamellae package 3″, 3″′ with the first PTC-heating element 4′. Accordingly, an upper centering element 33, a spring element 7 accepted thereby, and an uppermost retainer ring 1 together with the second PTC-heating element 4, the gasket 5, and the second-to-top retainer ring 1′ form a unit with lamellae packages 3, 3′ around the upper PTC-heating element 4.

A specialty separating the exemplary embodiment according to FIGS. 12, 13, and 14 from the exemplary embodiments of the previous figures relates to the electric connector elements 6, 6′, 6″: instead of eyelets, here contact plugs are used, which extend through the gaps 22, 22′, 22″, 22″′ and are mounted in the open interior space 20, 20″, 20″′ of the retainer rings 1, 1′, 1″, 1″′ in a contacting manner. For this purpose the retainer rings 1, 1′, 1″, 1″′ each comprise a centering part 36, 36″, with the electric connector elements 6, 6′, 6″ being placed thereupon. The central electric connector element 6′, used jointly by the two PTC-heating elements 4, 4′, is embodied here such that, on the one hand, it sits on the centering parts 36, 36″ of both allocated retainer rings 1′, 1″ in order to contact them and, on the other hand, forms an axial guidance for these two centering parts 36′, 36″, which increases the stability of the overall electric heating module not comprising a housing.

After the retainer rings 1, 1′, 1″, 1″′ with their lamellae packages 3, 3′, 3″, 3″′, the intermediate PTC-heating elements 4, 4′, the electric connector elements 6, 6′, 6″, and the spring elements 7, 7′ have been placed onto a U-shaped fastener, together with the two snapped fastening bars 8, 8′ forming a centering element 33′, the upper centering element 33 is compressed and the clip 11 is placed against the pre-stressing of the spring elements 7, 7′ upon the fastening bars 8, 8′. Here, the electric connector elements 6, 6′ pass through penetrations 34 in the right fastening bar 8. Instead of the clip 11, of course a second snap connection may be provided between the fastening bars 8, 8′ and the upper centering element 33.

1. An electric heating module for heating airflow, comprising at least one PTC-heating element (4) and at least one adjacent annular heat dissipation region (16), through which air can flow, having heat-conducting lamellae (3) arranged essentially extending radially, which are effectively connected to the PTC-heating element (4) to form a module, the lamellae (3) have a radially inner section positioned in a groove (2), adjusted to a width of the radially inner sections of the lamellae (3), at a perimeter of a heat conducting retainer ring (1).

2. An electric heating module according to claim 1, wherein the groove (2) of the retainer ring (1) is formed by two circumferential bars (24).

3. An electric heating module according to claim 2, wherein the retainer ring (1) has an I-beam shape in a side view.

4. An electric heating module according to claim 1, wherein the retainer ring (1) is cylindrical, at least in an area of the groove (2).

5. An electric heating module according to claim 1, wherein the retainer ring (1) is produced from aluminum as an extruded part.

6. An electric heating module according to claim 1, wherein the lamellae (3) are held clamped between lateral walls of the groove (2).

7. An electric heating module according to claim 6, wherein the bars (24) are compressed or swaged to the lamellae (3).

8. An electric heating module according to claim 1, wherein the lamellae (3) comprise at least one strip of sheet metal that is at least one of bent or folded in a meandering fashion.

9. An electric heating module according to claim 1, wherein the lamellae (3) are embodied such that narrow sides thereof extend generally in a sickle-shape.

10. An electric heating module according to claim 1, wherein the lamellae (3) are distorted in a radial progression thereof such that broadsides thereof are at least partially tilted in reference to an axial direction.

11. An electric heating module according to claim 1, wherein the retainer ring (1) comprises a contact surface (23) for a direct or indirect thermal contact to the PTC-heating element, extending essentially radially.

12. An electric heating module according to claim 11, wherein two retainer rings (1, 1′) with lamellae (3, 3′) are arranged axially behind each other, and the PTC-heating element (4) is arranged between the retainer rings (1, 1′) and is in heat conducting contact to both of the retainer rings (1, 1′).

13. An electric heating module according to claim 12, wherein the PTC-heating element (4) is positioned between the two contact surfaces (23, 23′) of the two retainer rings (1, 1′).

14. An electric heating module according to claim 13, wherein the PTC-heating element (4) is in electric contact to both of the retainer rings (1, 1′) and the retainer rings (1, 1′) comprise connector elements (6, 6′) for electric contact.

15. An electric heating module according to claim 12, wherein one electric connector element (6, 6′) and one insulating film (30, 30′) each are arranged between the PTC-heating element (4) and the two contact surfaces (23, 23′) of the two retainer rings (1, 1′), with the connector elements (6, 6′) each resting upon the PTC-heating element (4) and the insulating film (30, 30′) being positioned between the connector element (6, 6′) and the respective contact surface (23, 23′) of the retainer ring (1, 1′) in an electrically insulating fashion.

16. An electric heating module according to claim 15, wherein a soft-elastic gasket (5) or a positioning ring (35) is inserted between the two contact surfaces (23, 23′) of the two retainer rings (1, 1′), which circumferentially surrounds the PTC-heating element (4).

17. An electric heating module according to claim 16, wherein the soft-elastic gasket (5) has a cross-section expanding radially towards an outside thereof.

18. An electric heating module according to claim 16, wherein the positioning ring (35) comprises at least one of recesses (31) or insulating bars (32) for the electric connector elements (6, 6′).

19. An electric heating module according to claim 12, wherein three or more of the retainer rings (1, 1′, 1″) with corresponding ones of the lamellae (3, 3′, 3″) are arranged axially over top of each other, while at least one of the PTC-heating elements (4 and/or 4′) is located between two adjacent ones of the retainer rings (1, 1′ and/or 1′, 1″), and is in heat-conducting contact with both adjacent ones of the retainer rings.

20. An electric heating module according to claim 1, wherein the retainer ring (1) is divided in half along an axially extending separating plane, with the PTC-heating element (4) being positioned in the separating plane between two halves (25, 25′) of the retainer ring (1, 1′).

21. An electric heating module according to claim 20, wherein each of the halves (25, 25′) of the retainer ring (1) comprises a contact surface (23, 23′) adjacent to the separating plane, which the PTC-heating element (4) contacts electrically and in a heat conducting fashion.

22. An electric heating module according to claim 21, wherein a frame (26) is inserted between the two halves (25, 25′) of the retainer ring (1) to accept the PTC-heating element (4).

23. An electric heating module according to claim 21, wherein the two halves (25, 25′) of the retainer ring (1) are combined via spring clips (27).

24. An electric heating module according to claim 1, wherein at least two radial gaps (22) are provided between the lamellae (3) in a heat dissipation region (16) in order to each accept at least one a fastening bar (8).

25. An electric heating module according to claim 24, wherein an essentially U-shaped fastener (9) is provided, having at least two of the fastening bars (8, 8′) as U-legs, with a spring element (7) being provided at a U-back of the fastener (9), the retainer rings (12, 1′) with the lamellae (3, 3′) are inserted in the U-shaped fastener (9), and a clip (11) is placed upon ends of the fastening bars (8, 8′) which fixes the retainer rings (1,1′) and pre-stresses them against the spring element (7).

26. An electric heating module according to claim 24, wherein an essentially U-shaped fastener (9) is provided, having at least two of the fastening bars (8, 8′) as U-legs, the retainer rings (1, 1′) with the lamellae (3, 3′) are inserted in the U-shaped fastener (9), and a spring clip or a spring bar is placed upon ends of the fastening bars (8, 8′), which fixes the retainer ring or rings (1, 1′) and pre-stresses them against the U-back of the fastener (9).

27. An electric heating module according to claim 24, wherein the fastening bars (8) can be connected to each other via snap connections.

28. An electric heating module according to claim 27, wherein two of the fastening bars (8) can be connected to each other at least via a centering element (33) to accept a spring element (7).

29. An electric heating module according to claim 24, wherein the at least one fastening bar (8) is provided with openings (34) for electric connector elements (6, 6′).

30. An electric heating module according to claim 25, wherein the U-shaped fastener (9) is mounted to a housing (10), through which air can flow, or is integrated therein.

31. An electric heating module according to claim 30, wherein a ventilator (15) is mounted at the housing (10) or is inserted therein.

32. An electric heating module according to claim 31, wherein the housing (10) is designed for installation in a seat.

33. An electric module according to claim 32, further comprises a ventilated seat in which the housing is mounted in order to provide an airflow to the seat.
